(19) United States
(12) Patent Application Publication
(10) Pub. No.: US 2026/0272024 A1
(43) Pub. Date: Sep. 17, 2026

(54) AEROSOL GENERATOR

(71) Applicant: Nicoventures Trading Limited, London (GB)

(72) Inventors: Mark POTTER, London (GB); Richard HEPWORTH, London (GB)

(21) Appl. No.: 19/469,130

(22) PCT Filed: Mar. 28, 2024
(86) PCT No.: PCT/EP2024/058555

§ 371 Date: Sep. 25, 2025

(30) Foreign Application Priority Data
Mar. 29, 2023 (GB) 2304638.6
Mar. 29, 2023 (GB) 2304648.5
Sep. 12, 2023 (GB) 2313899.3

(51) Int. Cl. A24F 40/46; A24F 40/70; H05B 3/26

(52) U.S. Cl. CPC A24F 40/46; A24F 40/70; H05B 3/26; H05B 2203/003; H05B 2203/011; H05B 2203/021

(57) ABSTRACT

An aerosol generator of an article for an aerosol provision device is provided. The aerosol generator comprises aerosol generating material, a resistive heating layer comprising a resistive heating element configured to heat at least a portion of the aerosol generating material to generate an aerosol, the aerosol generating material being on the resistive heating layer, a first type of electrical contact, a second type of electrical contact, and a fold in the resistive heating layer to define an electrical contact region of at least one of the first type of electrical contact and the second type of electrical contact.

The resistive heating element being at least a portion of an electrically conductive path between the first type of electrical contact and the second type of electrical contact.

### CROSS-REFERENCE TO RELATED APPLICATIONS

This present application is a National Phase entry of PCT Application No. PCT/EP2024/058555, filed 28 Mar. 2024, which claims priority from Great Britain Application No. 2304638.6, filed 29 Mar. 2023, which claims priority from Great Britain Application No. 2304648.5, filed 29 Mar. 2023, and which claims priority from Great Britain Application No. 2313899.3, filed 12 Sep. 2023 each of which are fully incorporated herein by reference in their entireties.

### TECHNICAL FIELD

The present invention relates to an aerosol generator of an article for an aerosol provision device. The present invention also relates to an aerosol provision system, a method of forming an aerosol generator of an article for an aerosol provision device, and a blank for forming an aerosol generator of an article for an aerosol provision device.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

Aerosol provision systems, which cover the aforementioned devices or products, are known. Common systems use heaters to create an aerosol from a suitable medium which is then inhaled by a user. Often the medium used needs to be replaced or changed to provide a different aerosol for inhalation. It is known to use resistive heating systems as heaters to create an aerosol from a suitable medium.

### SUMMARY

According to an aspect there is provided, an aerosol generator of an article for an aerosol provision device comprising aerosol generating material, a resistive heating layer comprising a resistive heating element configured to heat at least a portion of the aerosol generating material to generate an aerosol, the aerosol generating material being on the resistive heating layer, a first type of electrical contact, a second type of electrical contact, and a fold in the resistive heating layer to define an electrical contact region of at least one of the first type of electrical contact and the second type of electrical contact, wherein the resistive heating element is at least a portion of an electrically conductive path between the first type of electrical contact and the second type of electrical contact.

In an embodiment of any of the above, an exterior of the article has a length, a width perpendicular to the length, and a depth perpendicular to each of the length and the width, wherein the length is greater than or equal to the width, and wherein the width is greater than the depth.

In an embodiment of any of the above, the article is tubular.

In an embodiment of any of the above, the resistive heating layer has a length, a width perpendicular to the length, and a depth perpendicular to each of the length and the width, wherein the length is greater than or equal to the width, and wherein the width is greater than the depth.

In an embodiment of any of the above, at least one of the first type of electrical contact and the second type of electrical contact may extend from the fold.

In an embodiment of any of the above, the first type of electrical contact and the second type of electrical contact may extend from the fold.

In an embodiment of any of the above, the fold may define the electrical contact region of the at least one of the first type of electrical contact and the second type of electrical contact extending from the fold.

In an embodiment of any of the above, aerosol generator may be elongate and may define a longitudinal axis.

In an embodiment of any of the above, the fold may extend along an axis perpendicular to the longitudinal axis.

In an embodiment of any of the above, the fold may define a longitudinal end of the aerosol generator.

In an embodiment of any of the above, the he aerosol generator may be elongate and may define a longitudinal axis.

In an embodiment of any of the above, the fold may extend along an axis parallel to the longitudinal axis.

In an embodiment of any of the above, the fold may be a first fold defining the first type of electrical contact.

In an embodiment of any of the above, the aerosol generator may comprise a second fold.

In an embodiment of any of the above, the second fold may define the second type of electric contact.

In an embodiment of any of the above, the first and second folds may be spaced from each other.

In an embodiment of any of the above, the first and second folds may extend parallel to each other.

In an embodiment of any of the above, the first and second folds may extend longitudinally.

In an embodiment of any of the above, the fold may define a terminal edge of the aerosol generator.

In an embodiment of any of the above, the terminal edge may extend perpendicular to a longitudinal direction of aerosol generator.

In an embodiment of any of the above, the resistive heating layer may comprise a heating element panel comprising the resistive heating element and a contact panel comprising the at least one of the first type of electrical contact and the second type of electrical contact.

In an embodiment of any of the above, the fold may be between the heating element panel and the contact panel.

In an embodiment of any of the above, the fold may be a first fold.

In an embodiment of any of the above, the aerosol generator may comprise a second fold.

In an embodiment of any of the above, the first fold may extend perpendicular to the second fold to define an end fold.

In an embodiment of any of the above, the first fold may extend perpendicular to the longitudinal axis of the aerosol generator.

In an embodiment of any of the above, the first fold may define a flap.

In an embodiment of any of the above, the flap may be between the heating element panel and the contact panel.

In an embodiment of any of the above, the first fold may be an end fold.

In an embodiment of any of the above, the second fold may extend longitudinally.

In an embodiment of any of the above, the first fold may define the terminal edge.

In an embodiment of any of the above, the flap may be sandwiched between the heating element panel and the contact panel.

In an embodiment of any of the above, the at least one of the first type of electrical contact and the second type of electrical contact may be defined at the first fold.

In an embodiment of any of the above, the fold may define each of the first type of electrical contact and the second type of electrical contact.

In an embodiment of any of the above, the aerosol generator comprises an aerosol generating layer comprising the aerosol generating material. In an embodiment of any of the above, the aerosol generating layer is on the resistive heating layer.

In an embodiment of any of the above, the aerosol generator comprises a support configured to support the resistive heating layer.

In an embodiment of any of the above, the support comprises a support layer.

In an embodiment of any of the above, the aerosol generator may comprise a support layer.

In an embodiment of any of the above, the resistive heating layer may be on the support layer.

In an embodiment of any of the above, the support layer may be electrically insulating.

In an embodiment of any of the above, the support comprises at least one of paper and card.

In an embodiment of any of the above, each of the resistive heating layer and the support layer are folded at the fold.

In an embodiment of any of the above, the aerosol generating material is in direct contact with the resistive heating layer. In an embodiment of any of the above, the aerosol generating layer is in direct contact with the resistive heating layer.

In an embodiment of any of the above, the aerosol generating material is in indirect contact with the resistive heating layer. In an embodiment of any of the above, the aerosol generating layer is in indirect contact with the resistive heating layer.

In an embodiment of any of the above, the resistive heating layer and the support layer define a substrate.

In an embodiment of any of the above, the aerosol generator comprises a laminate comprising the resistive heating layer and the support layer.

In an embodiment of any of the above, the laminate comprises the aerosol generating layer.

In an embodiment of any of the above, the support layer comprises a card layer.

In an embodiment of any of the above, the first type of electrical contact is configured to electrically connect with a device electrical connector and the second type of electrical contact is configured to electrically connect with the device electrical connector.

In an embodiment of any of the above, the support defines an exposed contact area of the first type of electrical contact.

In an embodiment of any of the above, wherein the exposed contact area is a first exposed contact area, and the support defines a second exposed contact area of the second type of electrical contact.

In an embodiment of any of the above, the aerosol generating layer is a continuous aerosol generating layer.

In an embodiment of any of the above, the aerosol generating layer is a discontinuous aerosol generating layer.

In an embodiment of any of the above, the aerosol generating layer comprises a plurality of discrete aerosol generating portions.

In an embodiment of any of the above, the resistive heating element may be one of a plurality of resistive heating elements.

In an embodiment of any of the above, one of the discrete aerosol generating portions is associated with a corresponding one of the plurality of resistive heating elements.

In an embodiment of any of the above, the aerosol generating layer comprises at least one of dots, strips and patches.

In an embodiment of any of the above, wherein the resistive heating element is a first heating element and the resistive heating layer forms a second resistive heating element, each resistive heating element providing an electrically conductive path for resistive heating of a portion of the aerosol generating material to generate an aerosol at the respective portion of the aerosol generating layer.

In an embodiment of any of the above, wherein the resistive heating layer forms an array of resistive heating elements comprising at least the first resistive heating element and the second resistive heating element.

In an embodiment of any of the above, the aerosol generator comprises a plurality of the first type of electrical contact, wherein each of the heating elements comprises a separate electrical contact of the first type.

In an embodiment of any of the above, the aerosol generator comprises a plurality of the second type of electrical contacts, wherein each of the resistive heating elements comprises a separate second type of electrical contact.

In an embodiment of any of the above, the aerosol generator comprises a single second type of electrical contact.

In an embodiment of any of the above, wherein the single second type of electrical contact is shared between each of the resistive heating elements. In an embodiment of any of the above, wherein each of the first type of electrical contact and the second type of electrical contact are configured to enable an electric current to be individually provided to each of the resistive heating elements.

In an embodiment of any of the above, wherein the aerosol generating layer comprises a film or gel layer comprising the aerosol generating material.

In an embodiment of any of the above, wherein the resistive heating element is formed by at least one of: cutting said resistive heating layer; chemically etching said resistive heating layer; forming or pressing the resistive heating layer in the substrate; and printing said resistive heating layer.

In an embodiment of any of the above, wherein the resistive heating layer is in the form of a foil.

In an embodiment of any of the above, comprising a gap in the resistive heating layer defining at least a portion of the resistive heating element. In an embodiment of any of the above, the gap defines an electrically insulative barrier. In an embodiment of any of the above, the gap defines an insulative barrier. In an embodiment of any of the above, the support layer is free from the gap. In an embodiment of any of the above, the gap extends through both the support layer and the resistive heating layer. In embodiments, the gap is a filled gap, for example with an insulative material.

In an embodiment of any of the above, the aerosol generator is at least partially formed by cutting the resistive heating layer and the support together. In an embodiment of any of the above, aerosol generator is at least partially formed using die cutting.

According to an aspect there is provided an article comprising the aerosol generator of any of the embodiments described above.

In an embodiment of any of the above, the article may be a consumable of an aerosol generating system.

According to an aspect, there is provided an aerosol provision device configured to receive the aerosol generator as described above or the article of any of the embodiments described above.

According to an aspect, there is provided an aerosol generating system comprising the article of any of the embodiments described above.

In an embodiment of any of the above, the aerosol provision device may be configured to receive the article.

According to an aspect, there is provided an aerosol provision device comprising an aerosol generator in accordance with any of the above, or an article in accordance with any of the above.

According to an aspect, there is provided a blank for forming an aerosol generator comprising a resistive heating layer comprising a resistive heating element configured to heat at least a portion of aerosol generating material on the resistive heating layer to generate an aerosol, first type of electrical contact, a second type of electrical contact, and a fold line in the resistive heating layer to define an electrical contact region of at least one of the first type of electrical contact and the second type of electrical contact. The resistive heating element is at least a portion of an electrically conductive path between the first type of electrical contact and the second type of electrical contact.

In an embodiment of any of the above, the blank may comprise an aerosol generating layer comprising aerosol generating material.

In an embodiment of any of the above, the aerosol generating material may be on the resistive heating layer. In an embodiment of any of the above, the aerosol generating layer may be on the resistive heating layer;

According to an aspect, there is provided a method of manufacturing an aerosol generator comprising providing a resistive heating layer, forming a first type of electrical contact of the aerosol generator, forming a second type of electrical contact of the aerosol generator, forming a resistive heating element on the resistive heating layer, wherein the resistive heating element is at least a portion of an electrically conductive path between the first type of electrical contact and the second type of electrical contact, and folding the resistive heating layer about a fold line to form a fold that defines an electrical contact region of at least one of the first type of electrical contact and the second type of electrical contact.

In an embodiment of any of the above, the method may comprise depositing an aerosol generating material comprising aerosol generating material on the resistive heating layer such that the resistive heating element can heat at least a portion of the aerosol generating material to generate an aerosol. In an embodiment of any of the above, the aerosol generating material may be in the form of an aerosol generating layer.

In an embodiment of any of the above, the first type of electrical contact may be formed on the resistive heating layer.

In an embodiment of any of the above, the second type of electrical contact may be formed on the resistive heating layer.

According to an aspect, there is provided an aerosol generator of an article for an aerosol provision device comprising: aerosol generating material; a resistive heating layer comprising a resistive heating element configured to heat at least a portion of the aerosol generating material to generate an aerosol; a first type of electrical contact; and a second type of electrical contact; and wherein the resistive heating element is at least a portion of an electrically conductive path between the first type of electrical contact and the second type of electrical contact.

According to an aspect, there is provided an aerosol provision device configured to receive an aerosol generator or an article for an aerosol provision device of any of the above.

According to an aspect, there is provided an aerosol provision system comprising an aerosol generator or an article for an aerosol provision device of any of the above, and an aerosol provision device of any of the above.

### BRIEF DESCRIPTION OF THE DRAWINGS

Various embodiments will now be described, by way of example only, with reference to the accompanying schematic drawings, in which:

FIG. 1 is a schematic perspective view of an aerosol provision system;

FIG. 2 is a schematic perspective view of an article comprising aerosol generating material of the aerosol provision system of FIG. 1;

FIG. 3 is a schematic perspective view of a first side of an aerosol generator of the article of FIG. 2;

FIG. 4 is a schematic perspective view of part of a second side of the aerosol generator of FIG. 3;

FIG. 5 is a schematic block diagram of an aerosol provision system such as the system shown in FIG. 1;

FIG. 6 is a schematic partially exploded perspective view of the article of FIG. 2, with an aerosol generator shown inverted from an assembled orientation and in a spaced relationship with other components;

FIG. 7 is a schematic cross-sectional view of another aerosol generator such as the aerosol generator shown in FIG. 3;

FIG. 8 is a schematic plan view of a heating element of the aerosol generator of FIG. 3;

FIG. 9 is a schematic plan view of a resistive heating layer of the aerosol generator of FIG. 3 with a plurality of heating elements;

FIG. 10 is a flow chart showing a method of forming an aerosol generator, such as the aerosol generator of FIG. 3;

FIG. 11 is an exploded perspective view of an aerosol generator being formed;

FIG. 12 is a schematic perspective view of a resistive heating layer of an aerosol generator being formed;

FIG. 13 is a flow chart showing a method of forming an aerosol generator, such as the aerosol generator of FIG. 3;

FIG. 14 is a flow chart showing a method of forming an aerosol generator, such as the aerosol generator of FIG. 3;

FIG. 15 is a flow chart showing a method of forming an aerosol generator, such as the aerosol generator of FIG. 3;

FIG. 16 is a schematic perspective view of a resistive heating layer of an aerosol generator being formed;

FIG. 17 is a schematic plan view of a heating element of an aerosol generator;

FIG. 18 is a schematic plan view of a heating element of an aerosol generator;

FIG. 19 is a schematic perspective view of part of an aerosol generator of the article of FIG. 2;

FIG. 20 is a schematic perspective view of a device connector of an aerosol provision device of the aerosol provision system of FIG. 1;

FIG. 21 is a schematic side view of the aerosol generating system of FIG. 1;

FIG. 22 is a flow chart showing a method of forming an aerosol generator, such as the aerosol generator of FIG. 3;

FIG. 23 shows a blank for forming an aerosol generator being formed;

FIG. 24A shows a blank for forming an aerosol generator;

FIG. 24B shows another blank for forming an aerosol generator;

FIG. 25 shows an aerosol generator formed from a blank;

FIG. 26 shows a schematic perspective view of an aerosol generator;

FIG. 27 shows a schematic perspective view of a distal end of the aerosol generator of FIG. 26; and

FIGS. 28 to 31 show part of a process of an aerosol generator being formed; and

FIG. 32 shows a flowchart of a method of forming an aerosol generator.

### DETAILED DESCRIPTION

As used herein, the term “delivery mechanism” is intended to encompass systems that deliver a substance to a user, and includes: non-combustible aerosol provision systems that release compounds from an aerosolisable material without combusting the aerosolisable material, such as electronic cigarettes, tobacco heating products, and hybrid systems to generate aerosol using a combination of aerosolisable materials; and articles comprising aerosolisable material and configured to be used in one of these non-combustible aerosol provision systems.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

As used herein, the term “aerosol-generating material” (which is sometimes referred to herein as an aerosolisable material) is a material that is capable of generating aerosol, for example when heated, irradiated or energized in any other way. Aerosol-generating material may, for example, be in the form of a solid, liquid or semi-solid (such as a gel) which may or may not contain an active substance and/or flavourants.

In some embodiments, the substance to be delivered comprises an active substance (sometimes referred to herein as an active compound).

The aerosol-generating material may comprise one or more active substances and/or flavours, one or more aerosol-former materials, and optionally one or more other functional material.

The aerosol-generating material may comprise a binder, such as a gelling agent, and an aerosol former. Optionally, a substance to be delivered and/or filler may also be present. Optionally, a solvent, such as water, is also present and one or more other components of the aerosol-generating material may or may not be soluble in the solvent. In some embodiments, the aerosol-generating material is substantially free from botanical material. In particular, in some embodiments, the aerosol-generating material is substantially tobacco free.

The aerosol-generating material may comprise or be in the form of an aerosol-generating film. The aerosol-generating film may comprise a binder, such as a gelling agent, and an aerosol former. Optionally, a substance to be delivered and/or filler may also be present. The aerosol-generating film may be substantially free from botanical material. In particular, in some embodiments, the aerosol-generating material is substantially tobacco free.

The aerosol-generating film may have a thickness of about 0.015 mm to about 1 mm. For example, the thickness may be in the range of about 0.05 mm, 0.1 mm or 0.15 mm to about 0.5 mm or 0.3 mm.

The aerosol-generating film may be continuous. For example, the film may comprise or be a continuous sheet of material.

The aerosol-generating film may be discontinuous. For example, the aerosol-generating film may comprise one or more discrete portions or regions of aerosol-generating material, such as dots, stripes or lines, which may be supported on a support. In such embodiments, the support may be planar or non-planar.

The aerosol-generating film may be formed by combining a binder, such as a gelling agent, with a solvent, such as water, an aerosol-former and one or more other components, such as one or more substances to be delivered, to form a slurry and then heating the slurry to volatilise at least some of the solvent to form the aerosol-generating film.

The slurry may be heated to remove at least about 60 wt %, 70 wt %, 80 wt %, 85 wt % or 90 wt % of the solvent.

The aerosol-generating material may be an “amorphous solid”. In some embodiments, the amorphous solid is a “monolithic solid”. The aerosol-generating material may be non-fibrous or fibrous. In some embodiments, the aerosol-generating material may be a dried gel. The aerosol-generating material may be a solid material that may retain some fluid, such as liquid, within it. In some embodiments the retained fluid may be water (such as water absorbed from the surroundings of the aerosol-Attorney generating material) or the retained fluid may be solvent (such as when the aerosol-generating material is formed from a slurry). In some embodiments, the solvent may be water.

The aerosol-former material may comprise one or more constituents capable of forming an aerosol. In some embodiments, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional materials may comprise one or more of pH regulators, colouring agents, preservatives, binders, fillers, stabilizers, and/or antioxidants.

The material may be present on or in a support, to form a substrate. The support may, for example, be or comprise paper, card, paperboard, cardboard, reconstituted material, a plastics material, a ceramic material, a composite material, glass, a metal, or a metal alloy.

An aerosol provision device can receive an article comprising aerosol generating material for heating. An “article” in this context is a component that includes or contains in use the aerosol generating material, which is heated to volatilise the aerosol generating material, and optionally other components in use. A user may insert the article into or onto the aerosol provision device before it is heated to produce an aerosol, which the user subsequently inhales.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-Attorney modifying agent. A consumable may also comprise an aerosol generator, such as a heater, that emits heat to cause the aerosol-generating material to generate aerosol in use. The heater may, for example, comprise a material heatable by electrical conduction.

Non-combustible aerosol provision systems may comprise a modular assembly including both a reusable aerosol provision device and a replaceable aerosol generating article. In some implementations, the non-combustible aerosol provision device may comprise a power source and a controller (or control circuitry). The power source may, for example, comprise an electric power source, such as a battery or rechargeable battery. In some implementations, the non-combustible aerosol provision device may also comprise an aerosol generating component. However, in other implementations the aerosol generating article may comprise partially, or entirely, the aerosol generating component.

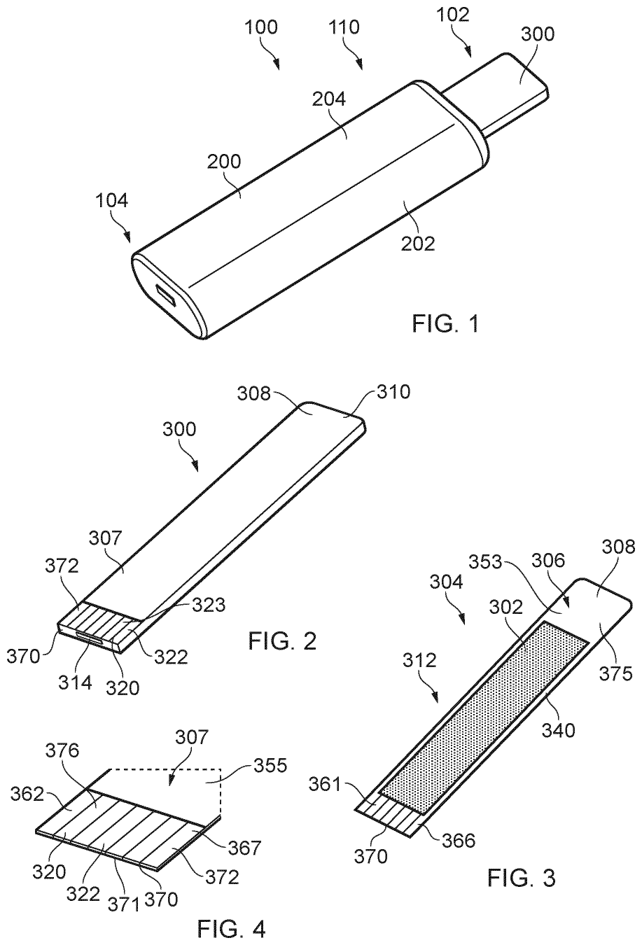

FIG. 1 shows a schematic view of an aerosol provision system 100. The aerosol provision system 100 comprises an aerosol provision device 200 and an article 300 comprising aerosol generating material 302 (refer to FIG. 3). The article 300 is shown in FIG. 2 removed from the aerosol provision device 200. An aerosol generator 304 of the article 300 is shown in FIG. 3 with a perspective view of a first side 306, with a perspective view of part of a second side 307 shown in FIG. 4.

The article 300 comprises the aerosol generator 304. The aerosol generator 304 is configured to generate an aerosol from the aerosol generating material 302 upon operation of the aerosol provision system 100, as will be describe in detail below.

The aerosol provision system 100 may be elongate, extending along a longitudinal axis. The aerosol provision system 100 has a proximal end 102, which will be closest to the user (e.g. the user's mouth) when in use by the user to inhale the aerosol generated by the aerosol provision system 100, and a distal end 104 which will be furthest from the user when in use.

The proximal end may also be referred to as the “mouth end”. The aerosol provision system 100 accordingly defines a proximal direction, which is directed towards the user when in use. Further, the aerosol provision system 100 likewise defines a distal direction, which is directed away from the user when in use. The terms ‘proximal’ and ‘distal’ as applied to features of the system 100 will be described by reference to the relative positioning of such features with respect to each other in a proximal-distal direction along a longitudinal axis.

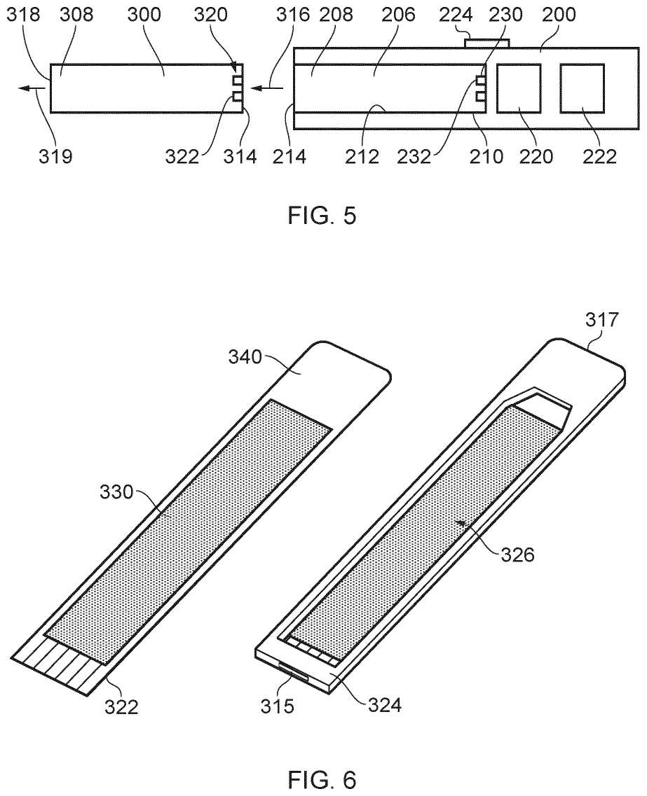

The article 300 is received by the aerosol provision device 200. The configuration of the article 300 and the aerosol provision device 200 may vary. In the present embodiment, the aerosol provision device 200 comprises a device body 202. The device has a housing 204 enclosing components of the device 200. An article receiving portion 206, sometimes referred to as a device chamber, as shown in FIG. 5, is configured to receive a portion of the article 300. A proximal end 308 of the article protrudes from the device 200 when the article 300 is received in the device chamber 206. A receptacle 208 defines the chamber 206. The receptacle 208 comprises a receptacle base 210 and a receptacle peripheral wall 212. The configuration of the receptacle 208 may vary in dependence on the configuration of the article 300.

One or more user-operable control elements 224, such as a button or switch, which can be used to operate the aerosol provision system 100 may be provided on the aerosol provision device 200. For example, a user may activate the system 100 by pressing the control element 224.

The aerosol provision device 200 comprises an opening 214 at the proximal end, leading into the device chamber 206. The opening 214 is provided in one end, through which the article 300 can be inserted. In embodiments, the article 300 may be fully or partially inserted into the device 200. The configuration of the device 200 may vary, for example the opening may be in a longitudinal side wall of the device 200, and/or may be closed by another feature of the device 200 during use. In the present configuration, the article 300 defines a mouthpiece 310 at the proximal end 308. In other embodiments, the device 200 defines the mouthpiece. The user places their mouth over the mouthpiece during use.

The device 200 defines the longitudinal axis along which an article 300 may extend when inserted into the device 200. The opening 214 is aligned on the longitudinal axis. The longitudinal axis may be an axis along which the article 300 is inserted into the device 200. The longitudinal axis may be considered to be a receiving axis of the device 200. The article 300 may similarly have a longitudinal axis along which it is inserted into the device and this axis may be considered to be an insertion axis.

The aerosol provision device 200 comprises a power source 220. The power source 220 may be a battery, for example a rechargeable battery. The device 200 also comprises a control circuit 222, acting as a controller, comprising a processor and a memory.

As discussed in detail below, a heating system 110 is configured to heat the aerosol generating material 302 of an article 300. The article 300 in embodiments is a consumable, and is interchangeable with other articles 300. The heating system 110 comprises the aerosol generator 304. The heating system 110 comprises other components of the aerosol provision system 100 including components of the article 300 and the aerosol provision device 200, for example the power source 220 and the control circuit 222.

The aerosol generator 304 forms part of the article 300. The aerosol generator 304 comprises a heating arrangement 312 configured to heat aerosol generating material 302, for example at least one of a film and a gel to generate an aerosol. The aerosol generating material may be referred to as aerosolisable material.

The heating arrangement 312 is a resistive heating arrangement. The or each heating element in embodiments is a resistive heating element, as described in detail below. In such arrangements the heating system 110 comprises a resistive heating generator including components to heat the heating arrangement 312 via a resistive heating process. In this case, an electrical current is directly applied to a resistive heating element, and the resulting flow of current in the heating element, acting as a heating component, causes the heating element to be heated by Joule heating. The resistive heating element comprises resistive material configured to generate heat when a suitable electrical current passes through it, and the heating arrangement 312 comprises electrical contacts for supplying electrical current to the resistive material. The provision of a resistive heating arrangement 312 allows for a compact arrangement. Resistive heating provides an efficient configuration.

In the use of the aerosol provision system 100, air is drawn into an air inlet 314 of the article 300, as indicated by arrow 316. The air inlet 314 is in a distal end of the article 300. In embodiments, the air inlet 314 may have a different configuration, for example in the side. The air flow to the air inlet 314 of the article 300 may be defined, for example by at least one of an air path through the device 200, an air path external to the device 200, and an air path between the device 200 and the article 300. An aerosol generated by the aerosol generator 304 exits the device at an aerosol outlet 318, as indicated by arrow 319. In embodiments the aerosol outlet 318 is in the mouthpiece of the article 300, such that the aerosol is drawn directly from the article 300 into the mouth of a user of the device 10.

In some example embodiments, the aerosol provision system comprises two main components, namely a control section forming a reusable part and a consumable section forming a replaceable or disposable part which may be referred to as a replaceable or disposable article or cartridge. As described herein, the aerosol provision device 200 forms a control section and the article 300 forms the consumable section. In the use of the aerosol generating system, the control section and the consumable part may be releasably connected at an interface. The consumable part may be removable and replaceable, for example when the consumable part is used, with the control section being re-used with a different consumable part.

The aerosol provision system 100 as shown is provided by way of example only and is highly schematic. Different aerosol generating devices and other devices may be used in example implementations of the principles described here. For example, in some example embodiments, air is drawn into an air inlet in the control section, passes through the interface, and exits the consumable part.

As shown schematically in FIG. 5, and described in detail below, the article 300 has an article electrical contact configuration 320. The electrical contact configuration 320 in embodiments is formed by the aerosol generator 304. The electrical contact configuration 320 comprises heater electrical contacts 322. The heater electrical contacts 322 may also be known as heater or article contacts. The aerosol provision device 200 comprises an electrical connector 230. The electrical connector 230 comprises connector electrical contacts 232. The connector electrical contacts 232 may also be known as connector or device contacts. The article electrical contact configuration 320 is configured to electrically communicate with the device electrical connector 230.

The configuration of the article 300 may vary. The article 300 comprises a body 324. The body 324 is hollow. The body 324 defines a flow path 326 (refer to FIG. 6) through the article 300. The flow path 326 extends between the air inlet 314 and the aerosol outlet 318. The flow path 326 is defined by an internal space in the article along which air and/or aerosol can flow. The flow path 326 is defined in the body 324. The or each aerosol generator 304 bounds the flow path 326. The aerosol generating material 302 is exposed to the flow path 326. The aerosol generating material 302 is exposed in the internal space. The internal space in embodiments comprises two or more chambers.

The air inlet 314 comprises an opening 315. The opening 315 is formed in the body 324. In embodiments, the opening is formed in another component of the article 300, for example the aerosol generator 304 or another wall feature. The aerosol outlet 318 comprises an outlet opening 317. The outlet opening 317 is formed in the body 324. In embodiments, the outlet opening 317 is formed in another component of the article 300, for example the aerosol generator 304 or another wall feature.

As shown in FIG. 6, the article 300 comprises two aerosol generators 304 forming an aerosol generator arrangement. The number of aerosol generators 304 may differ. Each aerosol generator 304 comprises aerosol generating material 302. The aerosol generating material 302 is exposed to the flow path 326. In embodiments the article 300 comprises a single aerosol generator 304. One of the aerosol generators 304 will be described in detail, with such detail being applicable to one or more further aerosol generators 304 in embodiments.

The or each aerosol generator 304 and the body 324 are formed in a stacked configuration. In embodiments, other arrangements such as a tubular arrangement of the article are envisaged. In such tubular arrangements the aerosol generator 304 defines a tubular configuration. Tubular may include circular cross-sectional, an elliptical cross section and other polygonal shapes.

In embodiments, as shown in the Figures, the article 300 has a flat configuration. That is, wherein an exterior of the article has a length, a width perpendicular to the length, and a depth perpendicular to each of the length and the width, wherein the length is greater than or equal to the width, and wherein the width is greater than the depth. Other configurations are envisaged.

FIG. 6 is a partially exploded perspective view of the article 300, with an aerosol generator 304 shown inverted from an assembled orientation and in a spaced relationship with other components. The article 300 comprises a first one of the aerosol generator 302, the body 324 and a second one of the aerosol generator. The body 324 spaces the first and second aerosol generators 304. The first and second aerosol generators 304 close the internal space defined by the body 324 along which air and/or aerosol can flow. The aerosol generating material 302 of the first and second aerosol generators 304 face each other and is exposed to the internal space. When assembled, the first and second aerosol generators 304 sandwich the body 324. In the embodiment of FIG. 6 at least, the first and second aerosol generators 304 and the body have equal plan areas. In embodiments, one or more of the first and second aerosol generators 304 and the body 324 has a greater length and/or width. In embodiments, one of the first and second aerosol generators 304 is replaced by a blank panel. The body 324 comprises a body layer. The body may comprise a plurality of body layers. The body layers may be formed in a stack and arranged to define features of the article 300, such as the air inlet 314 and aerosol outlet 318.

A wrap encircles the article 300 and forms part of the article 300. The wrap may comprise a sheet. The wrap acts as a fixed sleeve. The or each aerosol generator 304 protrudes from the wrap at a distal end. Exposed electrical contact regions 323 of the heater contacts 322 are exposed at the distal end. Other configurations are envisaged, for example at least one exposed electrical contact region 323 may additionally or alternatively be defined along a minor longitudinal face or edge of the article 300, and on a major face of the article defined by the aerosol generator 304.

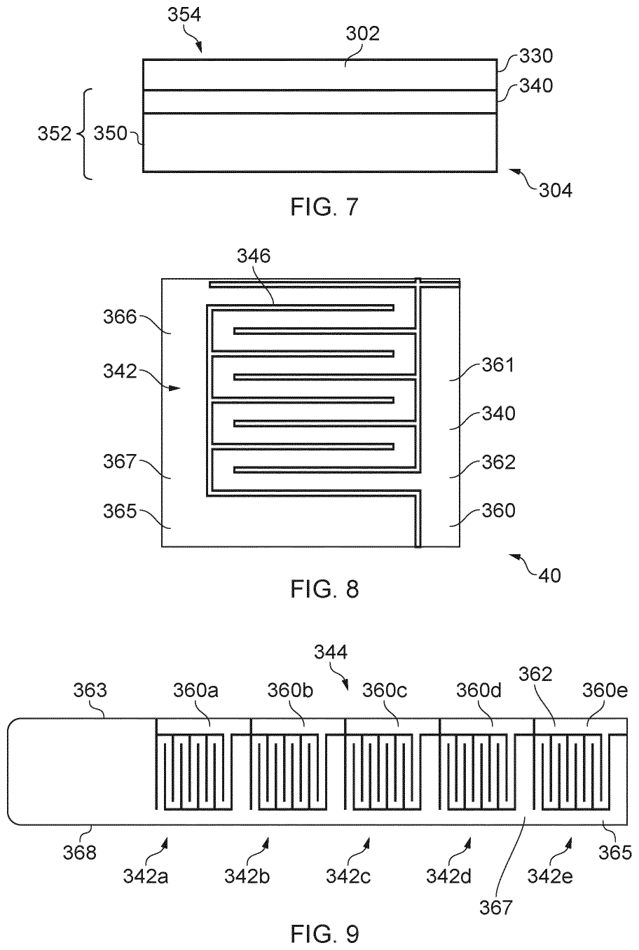

The aerosol generator 304 is schematically shown in cross section in FIG. 7. The aerosol generator 304 is an implementation of the aerosol generator 304 of the aerosol provision system 100 described above.

The aerosol generator 304 comprises an aerosol generating layer 330. The aerosol generating layer is also known as an aerosolisable layer. The aerosol generating layer 330 comprises the aerosol generating material 302. The aerosol generator 304 comprises a resistive heating layer 340. The resistive heating layer 340, in embodiments, is formed as an electrically conductive layer. The aerosol generating layer 330 is on the resistive heating layer 340. The aerosol generating layer 330 is in direct contact with the resistive heating layer 340. In embodiments, the aerosol generating layer 330 is in indirect contact with the resistive heating layer 340. The resistive heating layer 340 may in embodiments comprise a coating. As described in detail below, the resistive heating layer 340 comprises a plurality of resistive heating elements 342, for example as shown in FIGS. 8 and 9. The or each resistive heating element 342 forms at least a portion of an electrically conductive path between a pair of the electrical contacts 322. The or each resistive heating element 342 provides the electrically conductive path for resistive heating of at least of portion of the aerosol generating material 302 to generate an aerosol. The aerosol generating material 302 is, in embodiments, in the form of a film or a gel.

The resistive heating layer 340 is formed as an electrically conductive layer. This layer in embodiments takes the form of at least one of a metal layer, such as an aluminium layer, or a non-metallic material, such as graphene. The resistive heating layer 340 is in the form of a foil, for example an aluminium foil.

The aerosol generator 304 comprises a support 350. The support 350 in embodiments comprise a paper or card material. The support 350 provides structural support for the aerosol generator 304. The resistive heating layer 340 is on the support 350. The support 350 is configured as a support layer. As shown in FIG. 7, in the aerosol generator 304, the resistive heating layer 340 is sandwiched between the support 350 and the aerosol generating layer 330.

The support 350 is electrically insulative. The resistive heating layer 340 and the support layer 350 define a substrate 352. The substrate 352 supports the aerosol generating layer 330. In embodiments, the substrate 352 is defined by the resistive heating layer 340 alone.

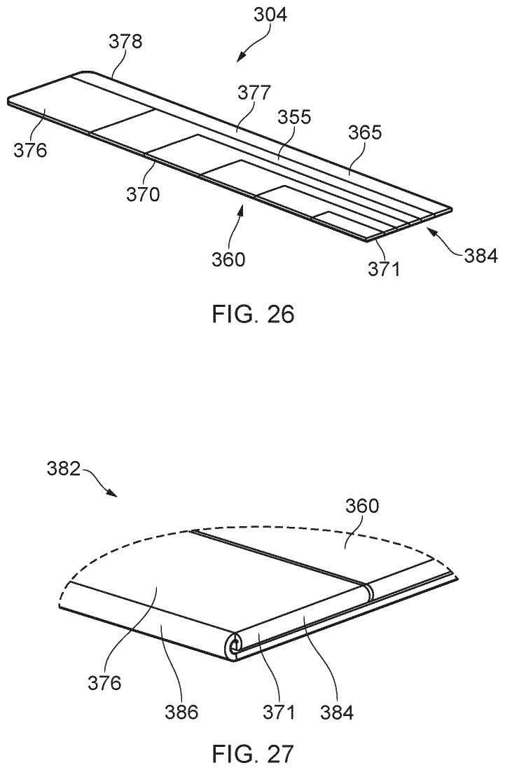

The substrate 352 has a first surface 353 at which the resistive heating elements 342 are arranged. The substrate has a second surface 355 at which the heater electrical contacts 322 are arranged. The first and second substrate surfaces 353, 355 oppose each other and define opposite surfaces of the substrate 352 as a panel. The aerosol generating layer 330 is on the first surface 353. As shown in FIGS. 2 to 4 for example, in embodiments the electrical tracks extend across a small proportion of the second surface, for example, less than 10%, optionally less than 20%, optionally less than 50%. In embodiments, such as shown in FIG. 26 for example, the heater electrical tracks extend across substantially the entire second surface, for example greater than 90%. The article 300 may comprise a laminate 354 comprising the resistive heating layer 340 and the support layer 350. In embodiments, the laminate 354 comprises the aerosol generating layer 330. The aerosol generating layer 330 may be formed as a contiguous configuration, or may be formed from discrete portions. The discrete portions may comprise one or more of dots, strips, spirals, or other shapes.

One or more of the aerosol generating layer 330, resistive heating layer 340 and the support layer 350 may comprise a further layer. For example the support layer 350 may comprise a backing layer or an intermediate layer. The support layer 350 in embodiments is omitted.

FIG. 8 shows one of the resistive heating elements 342. The resistive heating layer 340 comprises a plurality of resistive heating elements 342. In embodiments, the resistive heating layer 340 comprises a single resistive heating element 342.

The plurality of heating elements 342 may be formed in an array 344 as shown in FIG. 9. Other configurations are envisaged.

The resistive heating element 342 comprises a resistive heating path. The resistive heating path is formed by an electrically conducting path. The resistive heating path is non-straight. The resistive heating path is convoluted. The configuration of the resistive heating path may vary. The electrical resistance of the heating element 342 may be dependent on the nature of the resistive heating path in the conductive layer, for example the length, width, thickness and arrangement of the path.. The electrical resistance of the resistive heating path may also be dependent on the material from which the resistive heating path is formed.

The resistive heating element 342 extends between a first type of electrical contact 360 and a second type of electrical contact 365. The first type of electrical contact 360 is configured to provide a positive contact and the second type of electrical contact 365 is configured to provide a negative contact. Electrical current flows between the first type of electrical contact 360 and the second type of electrical contact 365 through the path. The contact arrangement may be reversed. The first and second types of electrical contacts 360, 365 are heater electrical contacts 322. The first and second types of electrical contacts 360, 365 form at least part of the article electrical contact configuration 320.

The meandering or serpentine nature of the path of the resistive heating element 342 is such that the electrical resistance of the path is increased when compared with a straight path between the first and second type of electrical contacts.

The resistive heating layer 340 may comprise a first type of electrical track 361 extending from the resistive heating element 342. The first type of electrical track 361 comprises the first type of electrical contact 360. The electrical contact 360 of the first type is configured to electrically connect with the device electrical connector 230. The first type of electrical contact 360 comprises a first type of exposed contact region 362. The first type of exposed contact region 362 is exposed on the article for direct connection with the device electrical connector 230.

The resistive heating layer 340 may comprise a second type of electrical track 366 extending from the resistive heating element 342. The second type of electrical track 366 comprises the second type of electrical contact 365. The electrical contact 365 of the second type is configured to electrically connect with the device electrical connector 230. The second type of electrical contact 365 comprises a second type of exposed contact region 367. The second type of exposed contact region 367 is exposed on the article 300 for direct connection with the device electrical connector 230.

As discussed in detail below, the conducting path of the resistive heating element 342 in embodiments is created by defining at least one electrically insulative barrier 346 in the resistive heating layer 340. In embodiments, the electrically insulative barrier 346 is formed by cutting barrier restrictions (i.e. electrically insulating portions), such as gaps, channels or slots into a sheet formed of electrically conductive material to form the resistive heating layer 340. In embodiments, the electrically conductive element 342 is preformed to define the or each resistive heating element 342 and then applied to the support 350. In embodiments, the resistive heating layer 340 is applied to the support 350, and the or each resistive heating element 342 then defined in the resistive heating layer 340. The or each restive heating element 342 defining the resistive heating layer 340 may be a printed heater.

The at least one electrically insulative barrier 346 defines the first and second types of electrical track 361, 366.

The insulative barrier may be an air gap. In embodiments, the insulative barrier is a filled gap, for example filled with an insulative material. The barrier defines a barrier to electrical conduction across the barrier.

The or each resistive heating element 342 defining the resistive heating layer 340 may be formed by a cutting action. Cutting may include die cutting. The resistive heating element may be formed by an action applied to the resistive heating layer only. In embodiments, the resistive heating element may be formed by an action applied to the resistive heating layer and the support layer, for example an action of cutting the resistive heating layer and the support layer.

In some embodiments, the tracks of the or each resistive heating element 342 have a width in the region of 0.5 mm to 1 mm (two example prototypes have widths of 0.93 mm and 0.72 mm respectively) and gaps between the tracks of less than about 0.25 mm (the same two example prototypes have gaps of 0.2 mm and 0.05 mm respectively). The or each resistive heating element 342 may have overall dimensions of the order of 10 mm×10 mm. Other dimensions are possible in other example embodiments. By forming the or each resistive heating element 342 of these dimensions from an aluminium foil of having a thickness of 0.006 mm and an electrical resistivity of between 2 and 6 μOhmcm, the resistance of the path has been calculated to be of the order of 1 Ohm. In one example embodiment, the resistance was measured at between 0.83 and 1.31 Ohms.

As shown in FIG. 9, the resistive heating layer 340 may be formed into a plurality of resistive heating elements, indicated generally by the reference numerals 342a, 342b, 242c, 342d and 342e. Each of the resistive heating elements 342a-342e extends from a respective one of the first type of electrical contact, indicated generally by the reference numerals 360a, 360b, 360c, 360d and 360e to a single second type of electrical contact 365. Each of the resistive heating elements 342a-342e is at least a respective portion of a respective electrically conductive path between a respective first type of electrical contact 360a-360e and the second type of electrical contact 365. Each of the resistive heating elements 342a-342e is configured to heat at least a respective portion of an aerosol generating material 302 disposed thereon. The number of electrical contacts may vary. As such, each resistive heating element 342a-342e extends between a discrete first type of electrical contact and a common second type of electrical contact. Each of the resistive heating element 342a-342e provides an electrically conductive path for resistive heating of a portion of the aerosol generating material 302 to generate an aerosol at the respective portion of the aerosol generator 304.

The separate first type 360a-360e of electrical contacts enable an electric current to be individually provided to each of the plurality of resistive heating elements 342a-342e . The heating of different zones of the aerosol generating layer 330 can be controlled. For example, an aerosol generator may be provided with five aerosol generating zones. The resistive heating layer 340 allows each of those zones to be activated separately. Accordingly, for example, five puffs of aerosol may be generated from a single consumable incorporating a single aerosol generator 304, and ten puffs of aerosol may be generated from a single consumable incorporating two aerosol generators 304.

In the example resistive heating layer 340, the plurality of first type of electrical contacts 360a-360e , for example a positive electrical connection, are provided and a single second type of electrical contact 365, for example a negative electrical connection is provided. The resistive heating elements 342a-342e share a common negative terminal. This is not essential to all implementations. For example, multiple contacts of the second type could be provided. In embodiments each resistive heating element 342a-342e comprises a corresponding one of the first type of electrical contact 360 and a corresponding one of the second type of electrical contact 365.

In the shown embodiment of FIG. 9 of the resistive heating layer 340, the first type of electrical contacts 360a-360e are arranged on a first edge 363 of the resistive heating layer 340 and the second type of electrical contact 365 is arranged on a second edge 368 of the resistive heating layer 340. This may allow for convenient connection of electrical power, but, of course, many other configurations are possible, some of which are discussed further below.

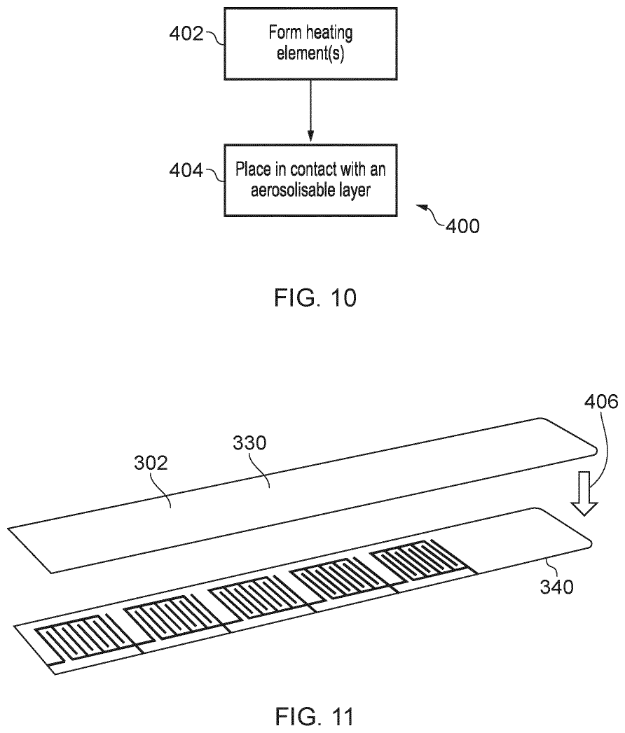

FIG. 10 is a flow chart showing part of a method of forming an aerosol generator 304 or an algorithm, indicated generally by the reference numeral 400, in accordance with an example embodiment.

The method or algorithm 400 starts at operation 402, where a resistive heating layer is formed into one or more heating elements (e.g. a plurality of heating elements), wherein each resistive heating element extends from an electrical contact of a first type to an electrical contact of a second type. In use, the or each heating element may be used to provide an electrically conductive path for resistive heating of a portion of an aerosol generating material to generate an aerosol. The formation of the or each resistive heating element may occur prior to or post application of the resistive heating layer on a support, where a support is present. The resistive heating layer may be adhered to the support, or mounted or formed on the support in a different configuration. At operation 404, the formed the resistive heating layer is placed in contact with the aerosol generating layer, wherein said aerosol generating layer incorporates aerosol generating material. Algorithm 400 may be used to produce the aerosol generator 304 described above.

FIG. 11 shows the aerosol generator 304 being formed in accordance with an embodiment. The aerosol generating material 302 is formed on the resistive heating layer 340 by depositing aerosol generating material, for example by spraying, painting, dispensing or in some other way. The aerosol generating layer 330 is disposed on resistive heating layer 340 as indicated by the arrow 406, in an example implementation of the operation 64.

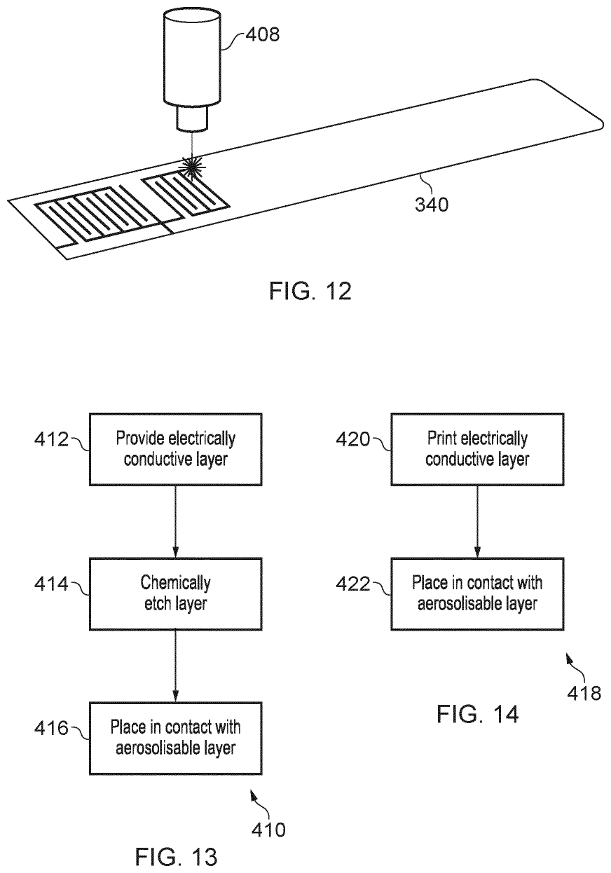

FIG. 12 shows the resistive heating layer 340 being formed in accordance with an example embodiment. The resistive heating layer 340 is in the process of being cut using a laser cutter 408. The cutting of the resistive heating layer 340 can be used to form the paths of the heating elements described herein. The use of the laser cutter 408 (or some other cutting process) is not the only method by which the resistive heating layer 340 described herein may be generated. Some example methods are described below.

FIG. 13 is a flow chart showing part of a method of forming an aerosol generator 304 or an algorithm, indicated generally by the reference numeral 410. The method or algorithm 410 starts at operation 412, where the resistive heating layer is provided. At operation 414, one or more of the resistive heating elements are formed in the resistive heating layer by chemically etching the resistive heating layer. The operations 412 and 414 are an example implementation of the operation 402 of the method 400 described above. The aerosol generating material is then disposed on the resistive heating layer, thereby implementing the operation 404 described above.

FIG. 14 is a flow chart showing part of a method of forming an aerosol generator 304 or an algorithm, indicated generally by the reference numeral 418. The method or algorithm 418 starts at operation 420, where one or more heating elements are formed, at least in part, by printing a resistive heating layer. The operation 420 is therefore an example implementation of the operation 62 of the algorithm 402 described above. The aerosol generating material is then disposed on the resistive heating layer, thereby implementing the operation 404 described above.

The cutting, etching and printing methods described above are provided by way of example; other additional or alternative methods are also possible. For example, a so-called “hot foiling” approach could be used in which a heating element is made out of a resistive heating layer, and then assembled/bonded onto a support. Yet other techniques could be used, such as die cutting. Moreover, two or more technologies could be combined (e.g. electrical conductivity could be added to connection traces by adding more conductive material, such as additional foil, printed material, etc.). The skilled person will be aware of many further technologies, or combinations of technologies, that could be used in implementations of the principles described herein.

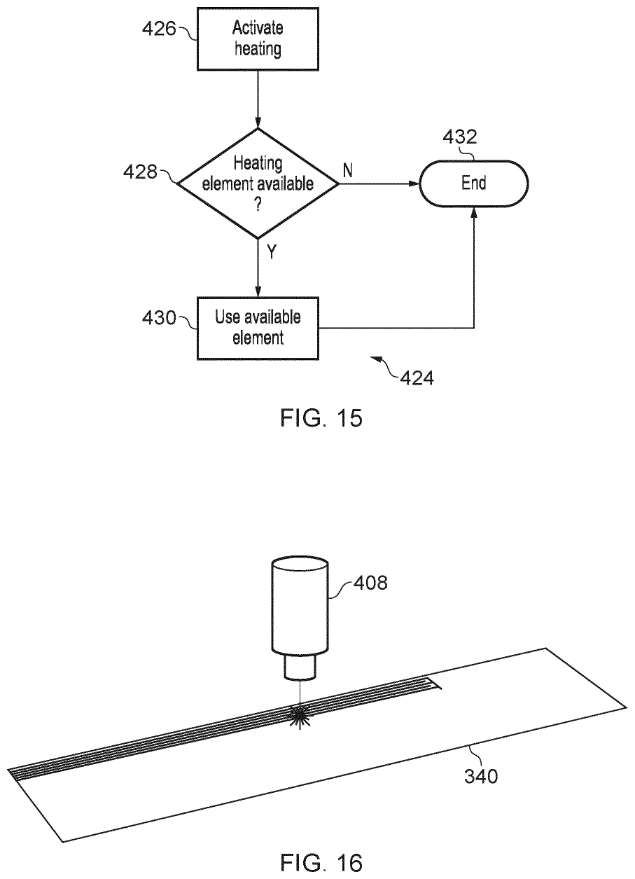

FIG. 15 is a flow chart showing method of operation or an algorithm, indicated generally by the reference numeral 424, in accordance with an example embodiment. The method or algorithm 424 may, for example, be implemented using any of the aerosol generators described herein. The method or algorithm 424 is initiated when an instruction to activate heating is received in an instance of operation 426. In response to the instruction to activate heating, a determination is made (in operation 428) regarding whether a heating element is available. As discussed above, a plurality of heating elements may be provided. The operation 428 may involve determination which of the heating elements have been used and/or the corresponding available aerosol generating material used up.

If a heating element is available, the algorithm moves to operation 430, where an available heating element is used. As discussed above, heating elements may be individually controllable, for example by providing electrical power to individual heating elements. Once the operation 430 is complete, the algorithm terminates at operation 432. If, at operation 428, a determination is made that no heating elements are available, for example because all heating elements have been used, then the algorithm terminates at operation 432. This may mean that a consumable part being used to implement the algorithm 424 needs to be replaced.

FIG. 16 shows the resistive heating layer 340 being formed in accordance with an embodiment. The resistive heating layer 340 is being cut using the laser cutter 408, although other methods could be used, such as chemical etching or printing, as discussed above. The cutting of the electrically conductive layer 340 forms the heating elements as described herein.

In the embodiment of FIG. 16, the paths cut are linear paths, extending along the length of the electrically conductive layer 120.

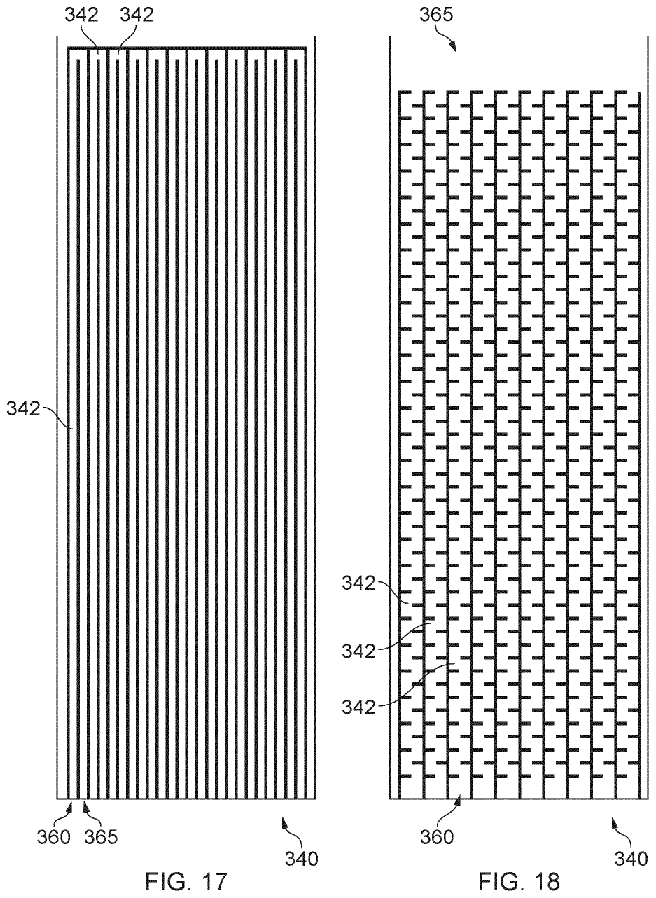

FIG. 17 shows another embodiment of the resistive heating layer 340. The resistive heating layer 340 may be formed using the laser cutter 408 described above, or some similar device or another method. The resistive heating layer 340 comprises a plurality of resistive heating elements 342, each resistive heating element 342 being a linear heating element comprising a conducting path extending along a length of the resistive heating layer 340. Each resistive heating element 342 extends from one of the first type of electrical contact 360, for example a positive electrical connection to one of the second type of electrical contact 365, for example a negative electrical contact. In such an embodiment, both types of electrical contact are provided at the same end of the resistive heating layer 340 and are provided next to each other. In such an arrangement that there is free from a common second type of electrical contact as is some other embodiments; instead, each heating element has separate first and second types of electrical contacts.

FIG. 18 shows another embodiment of the resistive heating layer 340. The resistive heating layer 340 may be formed using the laser cutter 408 described above, or some similar device or another method. The resistive heating layer 340 comprises a plurality of heating elements 342, each heater element 342 being a linear heating element comprising a conducting path extending along a length of the resistive heating layer 340. Each resistive heating element 342 extends from one of the first type of electrical contact 360, for example a positive electrical connection to the second type of electrical contact 365, for example a negative electrical contact. In such an embodiment, the different types of electrical connection are provided at the opposite ends of the resistive heating layer 340 and a common second type of electrical contact is provided. Although a linear path is provided, an increase in the electrical resistance may be provided by means of providing a crenelated path, acting as a convoluted path. Note that the paths of any other embodiments described herein could also be crenelated.

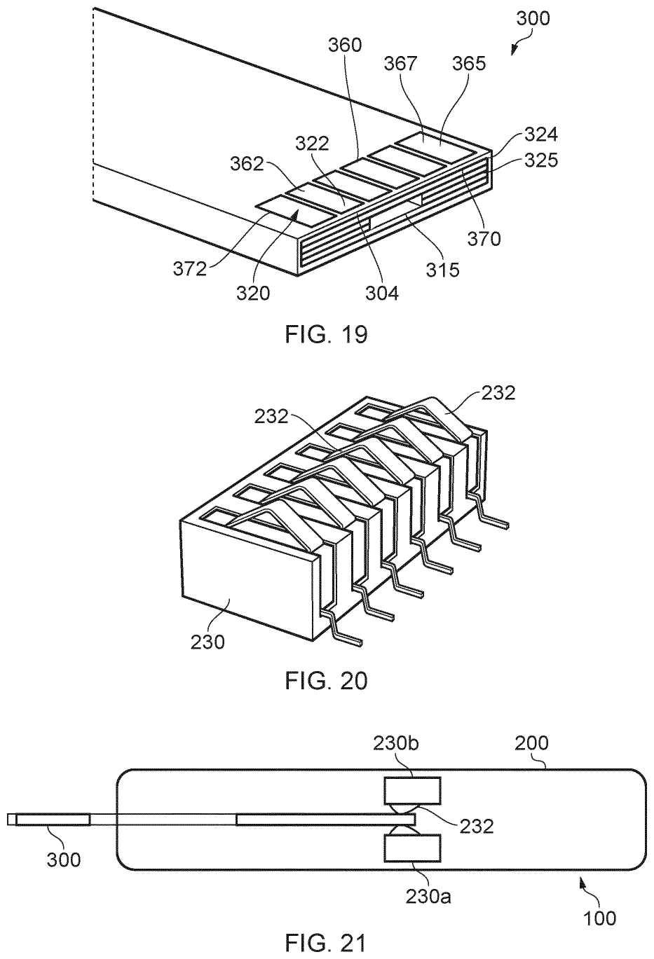

FIG. 19 shows the distal end of the article 300. As shown, the body 324 comprises a plurality of body layers 325. The body layers 325 are arranged in a stack of body layers 325. The body layers 325 form a laminate. The body layers 325 in embodiments are card layers. Other suitable materials may be used. The body layers 325 are configured to define features of the article 300. At least one body layer in embodiments comprises a gap defining the air inlet 315. The gap defines the opening 314.

The aerosol generator 304 comprises the resistive heating layer 340. The resistive heating layer 340 comprises the resistive heating elements 342, the first type of electrical contacts 360, for example providing positive electrical connections to each of a plurality of heating elements 342 and a single second type of electrical contact 365, for example providing a common negative electrical connection to the plurality of heating elements 342. The first and second types of electrical contacts 360, 365, namely the heater contacts 322, together form at least part of the article electrical contact configuration 320 of the aerosol generator 304.

The resistive heating elements 342 are on an inner side of the resistive heating layer 340. The inner side defines the first side 306 of the aerosol generator 304 as shown in FIG. 3. The heater contacts 322 are on the second side 307 of the resistive heating layer 340. The second side 307 defines an outer side of the aerosol generator 304. The heater contacts 322 are exposed so that they are able to be brought into contact with the device electrical connector 230. The heater contacts 322 are on an opposing side of the resistive heating layer 340 to the resistive heating elements 342. Other configurations are envisaged.

The support layer 350 is between an inner portion of the resistive heating layer 340 and an outer portion of the resistive heating layer 340.

A fold 370 is formed in the resistive heating layer 340. The fold 370 defines the heater contacts 322. The fold 370 as shown in FIGS. 2 to 4 and 19 extends perpendicular to the longitudinal axis of the aerosol generator 304. The fold 370 defines a flap 372. The heater contacts 322 are on the flap 372. The flap defines a contact panel 376. The remaining part of the blank defines a heating element panel 375. The resistive heating elements 342 are on the heating element panel 375.

In embodiments with the support layer 350, the support layer 350 in embodiments is folded. The substrate 352 is folded at the fold 370. In embodiments, the support layer 350 ends at the fold. In embodiments, the fold 370 extends parallel to the longitudinal axis of the aerosol generator 304.

The folded portion of resistive heating layer 340 is affixed in the folded position. This folded portion in embodiments is adhered, for example by bonding. Other fixing means are anticipated.

The fold 370 defines the first type of exposed contact region 362. The fold 370 defines the second type of exposed contact region 367. The electrical tracks 361, 366 electrically communicate across the fold 370. The heater contacts 322 of the first type of electrical track 361 and the second type of electrical track 366 are defined on the second side of the resistive heating layer 340. Portions of the first type of electrical track 361 and the second type of electrical track 366 extend on the first side of the resistive heating layer 340. In embodiments the resistive heating elements extend from the fold 370. Other configurations are anticipated.

The fold 370 defines a terminal edge 371. The heater contacts 322 of the first type of electrical track 361 and the second type of electrical track 366 extend on the terminal edge. By providing the fold 370, an exposed edge, for example a cut edge of the substrate 352 may be prevented from coming into contact with a connector of the device 200 into which the article 300 is inserted and so increase the reliability of contact. The fold helps to reduce or prevent damage to the resistive heating layer and/or substrate during handling e.g. during manufacture. In embodiments, the device contacts of the device connector may electrically connect with the terminal edge. Such an arrangement may minimise the thickness of any such device 200.

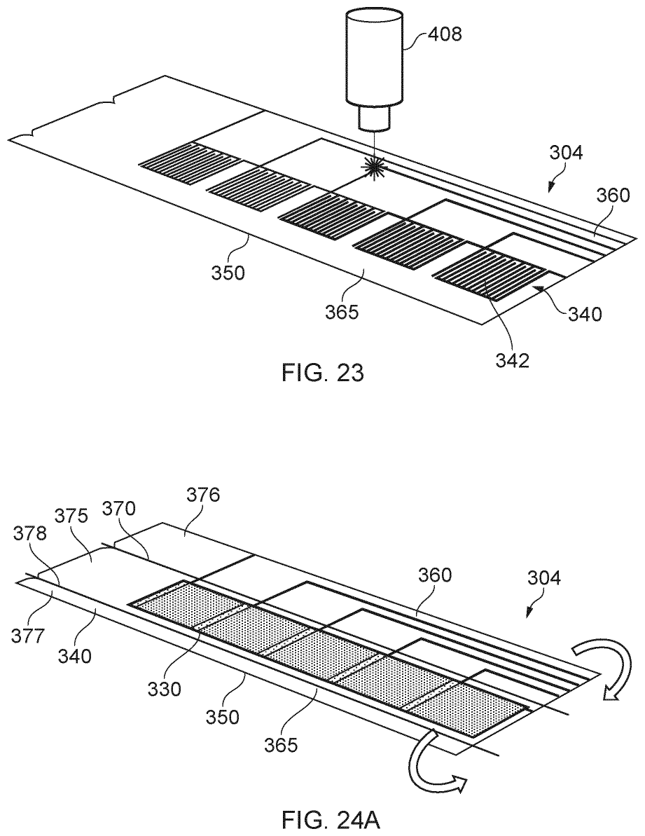

As shown in FIG. 4, the fold 370 is formed an end of the aerosol generator 304 perpendicular to the longitudinal axis. The fold 370 is formed between the contact panel 376 and the heating element panel 375. In embodiments described herein, for example with reference to FIGS. 23 to 25, the fold 370 extends parallel to the longitudinal axis. In such embodiments, the fold may form a terminal edge extending longitudinally. In other embodiments, further panels and folds are defined to form the terminal edge.

The aerosol generator 304 comprises a plurality of connector electrical contacts 232 of the electrical connector 230. The configuration of the device connector 230 is dependent on the configuration of the heater contacts 322 of the aerosol generator 304. In embodiments, such as the aerosol generator as shown in FIG. 19, the aerosol generator 300 comprises a plurality of heater contacts 322 including a plurality of the first type of heater contact 360 and one of the second type of heater contact 365. The article 300 comprises another set of heater contacts 322 on the opposing side of the article 300 corresponding to the second aerosol generator 304.

FIG. 20 shows a device connector 230 of the aerosol provision device 200 used in some embodiments. The connector 230 has separate connector electrical contacts 232 for connection with the heater contacts 322.

FIG. 21 schematically shows the aerosol provision system 100. The system 100 comprises the article 300 and aerosol provision device 200, both shown in block diagram. The device 200 comprises first and second connectors 230a and 230b.

The connectors 230a and 230b enable the aerosol provision device 200 to provide regulated or controlled electrical voltages and/or currents to the various first and second type of heater contacts 360, 365 of the aerosol generator 304 when the article 300 is inserted into the aerosol provision device 200. The aerosol provision device 200 may comprise a connector arrangement configured to provide electrical power to the connectors 230a, 230b. The aerosol provision device 200 may, for example, operate the method as described above.

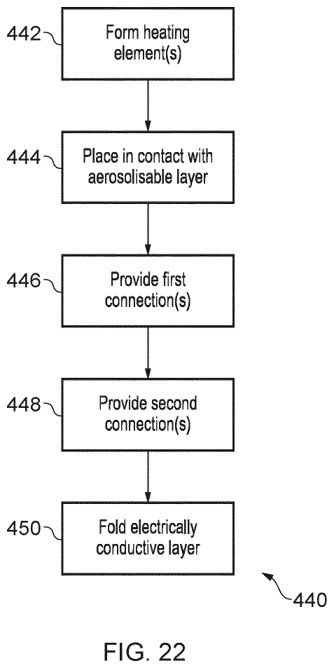

FIG. 22 is a flow chart showing a method of forming an aerosol generator 304 or an algorithm, indicated generally by the reference numeral 440, in accordance with an example embodiment.

The method or algorithm 440 starts at operation 442, where a resistive heating layer is formed into at least one resistive heating element, the or each heating element providing an electrically conductive path for resistive heating of at least a portion of an aerosolisable material to generate an aerosol. Example heating elements that may be formed in the operation 442 are described elsewhere in this document.

At operation 442, an aerosol generating material is applied and/or formed on the resistive heating layer.

The operations 442 and 444 of the method or algorithm 440 are similar to (and may be identical to) the operations 402 and 404 of the method or algorithm 400 described above.

In operation 446 at least one first type of electrical contact is provided on the resistive heating layer. The method of formation may be any of the methods described above. In operation 448 at least one second type of electrical contact is provided on the resistive heating layer. The method of formation may be any of the methods described above.

In embodiments, the first and second types of electrical contact are formed along or proximal a single edge of the resistive heating layer. In embodiments, the first and second types of electrical contact are formed along or proximal to different edges of the resistive heating layer.

In embodiments, the first types of electrical contact (e.g. positive connection(s)) are provided along a first edge of the resistive heating layer. In embodiments, the second types of electrical contact (e.g. negative electrical connection(s)) are provided along a second edge of the resistive heating layer. The operations 446 and 448 could be performed in a different order, or at the same time. Moreover, the operations 446 and 448 could be performed together with the operation 442.

At operation 450, the resistive heating layer is folded. In embodiments, the support layer is folded together with the resistive heating layer. In embodiments, the resistive heating layer is folded such that electrical contacts of the first and second type are provided adjacent to one another, as discussed in detail below.

FIGS. 23 to 25 show an embodiment of the aerosol generator 304 being formed in accordance with the algorithm 440.

FIG. 23 shows another embodiment of the aerosol generator 304 being formed. The resistive heating layer 340 is being cut using a laser cutter 408. The pre-folded configuration defines a blank for forming the aerosol generator 304. The blank in embodiments defines fold lines along which folds are made during formation of the aerosol generator. The aerosol generator 304 blank comprises the resistive heating layer 340 and the support layer 350. The resistive heating layer 340 and the support layer 350 define panels defined by the fold lines.

As shown in FIG. 23, the resistive heating layer 340 is formed into a plurality of heating elements 342, although the number may differ and may be one. A plurality of the first type of the electrical contact 360 (e.g. positive electrical contact) are provided along the first edge of the electrically conductive layer (one contact for each heating element is shown). A single second type of electrical contact 365 is provided along the second edge of the resistive heating layer 340. In embodiments the contacts are spaced from the edges. As discussed above, each heating element of the plurality extends from an electrical contact of the first type to an electrical contact of the second type.

The cutting of the resistive heating layer 340 by the laser cutter 408 forms the paths of the or each heating element 342. As discussed above, laser formation or some other cutting process is not the only method by which the resistive heating layer 340 described above may be generated. Some example alternative methods include chemical etching and printing.

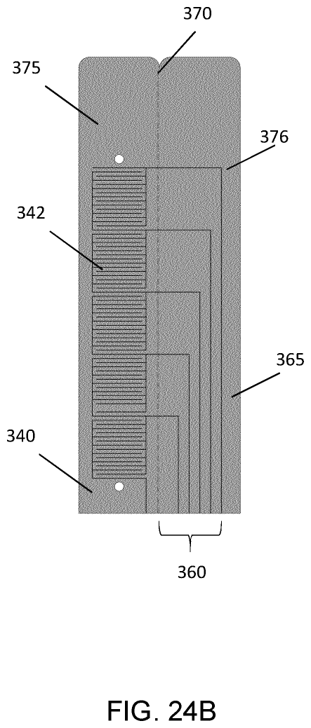

As indicated in FIG. 24A, the aerosol generating layer 200 is provided on the resistive heating layer 340. The blank is then folded, as indicated by the arrows in FIG. 24A. In embodiments, these steps are reversed. In this embodiment, the folds are formed parallel to a longitudinal direction of the aerosol generator 304. Two folds are formed. First fold 370 is formed between the heating element panel 375 and first contact panel 376. The first, heating element, panel 375 is defined comprising the heating elements 342. A first contact panel 376 is formed comprising the plurality of the first type of the electrical contact 360. A second contact panel 377 is formed comprising the second type of electrical contact 365. The second fold 378 is formed between the heating element panel 375 and second contact panel 377. The aerosol generating layer 330 is on the heating element panel 375. The or each fold is free from the aerosol generating layer 330.

In some embodiments, there is only one of the first and second contact panels 376, 377. In some embodiments, there is only one of the first and second fold lines 370, 378. In other words, only one of the first and second contact panels 367, 377 are folded over.

Referring for example to FIG. 24B, an embodiment is shown of the aerosol generator comprising a single fold. The fold is defined by fold line 370. The fold 370 is formed in the electrically conductive layer 340. The fold defines the heating elements 342 on the heating element panel 375. The fold extends parallel to the longitudinal axis of the aerosol generator. The fold 370 defines a contact panel 376. The first and second types of electrical contacts 360, 365. The remaining part of the blank defines the heating element panel 375. The fold line 370 in embodiments is predefined. The fold line extends perpendicular to the longitudinal direction, although other arrangements are anticipated. The fold line is linear. The contact panel 376 comprises the plurality of the first type of electrical contact 360 and the second type of contact 365. As shown, there is a single second type of electrical contact 365. In embodiments there are a plurality of second type of electrical contact 365. As shown, each of the plurality of the first type of electrical contact 360 and the second type of contact 365 is on the contact panel 376. In embodiments, at least one of the plurality of the first type of electrical contact 360 and the second type of contact 365 is on the heating element panel 375. The contact panel 376 defines an electrical contact region. In this embodiment, there is a single electrical contact region. By utilising a single fold, it may be more straightforward to align the article contacts with the device contacts. The manufacture of the device and the article may also be more straightforward because there may be a reduction in tolerance build up.

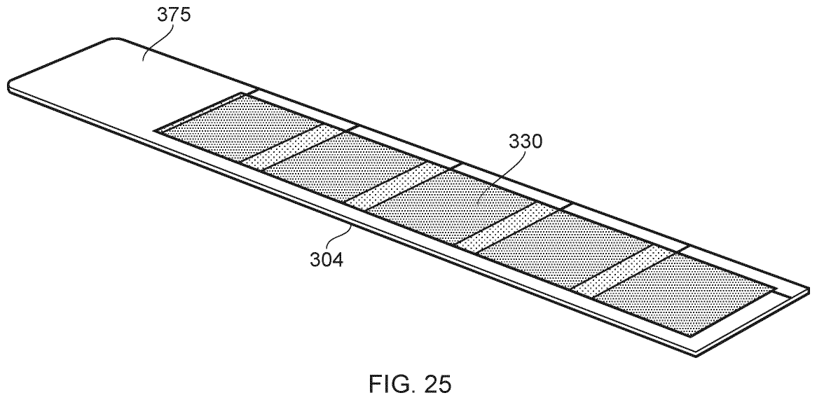

FIG. 25 shows a schematic perspective view of the heating element side of the folded aerosol generator 304. The electrical tracks extend from the first side of the aerosol generator 304 on which the heating elements 342 are disposed to a second side on which the electrical contacts 360, 365 are disposed.

FIGS. 26 to 31 shows another embodiment of the aerosol generator. The aerosol generator has substantially the same features as the embodiments of aerosol generator described above, and so a detailed description will be omitted. Features of the embodiments described above are applicable to the embodiments described below and vice versa. In the arrangement of the aerosol generator shown in FIG. 26, the substrate 352 is folded about the first and second folds 370, 378 with the heating element panel 375 defining a first panel layer, and the first and second contact panels 376, 377 defining a second panel layer. The first and second panel layers extend parallel to each other.

FIG. 27 is a view of the distal end of the aerosol generator 304 shown in FIG. 26. The aerosol generator of FIGS. 26 and 27 is generally the same as the aerosol generator 23 to 25, however in this embodiment an end fold 384 is formed to define the terminal edge 371.

The first and second type of electrical contacts 360, 365 extend on the second substrate surface 355. In this arrangement, the connection point or contact point with the power source 220 can be provided on the second substrate surface 355, which is spaced from the resistive heating elements 342.

The electrical contact region of the first type of electrical contact 360 and the second type of electrical contact 365 is distal from the resistive heating elements 342.

The electrical contact region of the first type of electrical contact 360 and the second type of electrical contact 365 is free from overlap with the resistive heating elements 342. This arrangement helps to reduce damage to the resistive heating element 342 during use as the most likely position of sparks and shorts, i.e. the contact points with the power source 220, is distal to and/or spaced from the resistive heating elements. Moreover, since the aerosol generating layer 330 is deposited on the resistive heating elements, this arrangement allows the electrical contacts to be provided away from the airflow path for carrying the aerosol generated from the aerosol generating layer. This helps to improve the quality of the aerosol delivered to the user as obstructions in the airflow path are minimised. The corresponding folded arrangements of, for example FIGS. 2 to 4 and 19, also may also help provide such an advantage.

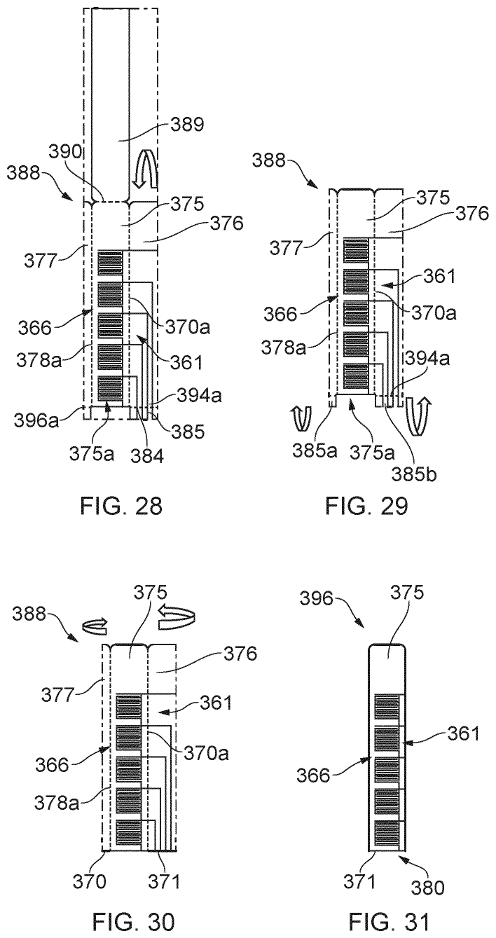

The first and second type of electrical contacts 360, 365 in embodiments, for example as shown in FIG. 26, extend to a position on the second surface that is adjacent to each other. This may be due to the pre-set sizes of the first and/or second type electrical contacts 360, 365 or the pre-set sizes of the first and second contact panels 376, 377. Advantageously, this allows for a reduced size in the electrical connector 230 in the aerosol provision device 200 as the distance between the first and second type of electrical contacts 360, 365 tends to be reduced and/or minimized. Further, the provision of two longitudinal fold lines minimises the number of exposed cut edges defining the edge of the aerosol generator 304. These are discussed in more detail in relation to FIG. 28 below.

The first and second type of electrical contacts 360, 365 each extends to the terminal edge 371 of the aerosol generator 304. The terminal edge 371 extends perpendicular to the longitudinal direction.

The terminal edge 371 is defined by the end fold 384, described in detail below. The end fold 384 allows the device electrical connector 230 to be positioned at the bottom of the receptacle of the aerosol provision device 200. Advantageously, this helps to provide more stable connections of the electrical contacts with the device connector 230. The end fold may aid with preventing damage to the substrate. In embodiments, each of the first and second type of electrical contacts do not extend to the terminal longitudinal edge of the aerosol generator in the longitudinal direction.

The distal end of the aerosol generator is shown in FIG. 27. The end fold 384 defining the terminal edge 371 is shown. The end fold 384 forms a flap arrangement 385 (refer to FIG. 28) of the resistive heating layer 340. In an arrangement with two longitudinal folds, two flaps define the flap arrangement and are defined by the end fold 340. In an arrangement with a single longitudinal fold, a single flap defines the flap arrangement and is defined by the end fold 340. The or each flap of the flap arrangement 385 is sandwiched between the first panel layer, i.e. a heating element panel layer and the second panel layer, i.e. a contact panel layer. Such an arrangement ensures that the terminal edge 371 is free from an exposed cut edge. The end fold 384 defining the terminal edge 371 aids to increase the exposed contact area. The end fold aids to provide a chamfer at the terminal edge 371.

The one or more folds at the terminal longitudinal edge 380 help to provide rigidity and structural integrity due to the extra layer of material. The end fold 384 provides for an additional layer in the stack of layers at the terminal edge to help increase rigidity of the terminal edge. As such, damage or deformation to the aerosol generator tends to reduced or eliminated. This damage or deformation may be problematic during insertion the aerosol generator into the aerosol provision device. Advantageously, the fold tends to help reduce damages and/or deformation when handling the aerosol generator, for example during the insertion of the aerosol generator and/or an article formed therefrom into an aerosol provision device. Furthermore, edges of the layers that are free from a fold, for example a cut edge, tend to have grains/fibres that are exposed and may have tendency to become frayed. For example, the resistive heating layer may be delaminated from the underlying support layer at the edges if those edges are free from a fold, for example a cut edge. Again, this may be prevalent during insertion of the aerosol generator into an aerosol provision device. Advantageously, the fold moves the vulnerable ends away from the terminal edge of the aerosol generator 304 thereby reducing or eliminating the risk that the terminal edges are frayed. Furthermore, in an article or aerosol provision device containing such an aerosol generator 304, the flap may be positioned between the resistive heating elements and an outer surface defined the article or the aerosol provision device. In these arrangements, the fold and/or flap may provide an insulation layer, acting as insulation. Such insulation acts between the outer surface and the resistive heating elements thereby minimising heat transfer to a user.

FIGS. 28 to 31 show the formation of the aerosol generator from a blank 388. The blank is formed by the substrate 352. The blank 388 is provided formed from a substrate arrangement. In this embodiment, the blank 388 defines the heating element panel 375, the first contact panel 376, and the second contact panel 377. These panels correspond generally to the panels discussed above. The blank 388 further comprises the flap arrangement 385. The blank 388 includes a core panel 389. The core panel 389 in embodiments is omitted. In some embodiments, the core panel 389 may be provided adjacent to the first contact panel 376. In other words, the first contact panel 376 is positioned between the core panel 389 and the heating element panel 375. In these embodiments, the core panel 389 is electrically coupled to each of the first type of electrical contacts. As such, the core panel 389 provides a contact testing area to test resistances of each of the first type of electrical contacts during manufacture. The core panel 389 can then be folded away after testing. No further processing needs to be performed to minimize the impact of the core panel 389 on the functionality of the final aerosol generator 304. In other embodiments, the core panel 389 is provided adjacent to the second contact panel 377 such that the second contact panel 377 is positioned between the core panel 389 and the heating element panel 375. Advantageously, these arrangements allow for the efficient provision of a contact testing area. In other words, a contact testing area may be provided significantly adding components and/or without significant complications, e.g. processing of the contact testing area. The blank 388 further defines a first contact panel fold line 370a extending along the longitudinal direction on the first type of electrical contacts 360. The first contact panel fold line 370a is arranged between the heating element panel 375 and the first contact panel 376. Folding the resistive heating layer 340 about the first contact panel fold line 370a results in the first contact panel fold 370 extending along the longitudinal direction. The first contact panel fold 370 would define a first longitudinal edge of the aerosol generator. The first type of electrical tracks 361 would extend from the first side to the second side via the first contact panel fold 370.

The blank further comprises a second contact panel fold line 378a extending along the longitudinal direction on the second type of electrical contacts 365. Folding the resistive heating layer 340 about the second fold line 378 results in the second contact panel fold 378 extending along the longitudinal direction. The second contact panel fold 378 would define a second longitudinal edge of the aerosol generator. The second type of electrical tracks 366 would extend from the first surface to the second surface via the second contact panel fold 377.

The heating element panel 375 comprises a distal end 375a. The first and second contact panels 376 each extend beyond the heating element panel distal end 375a.

The first and second contact panels 376 define an end fold 384. The end fold 384 is defined by an end fold line. The end fold 384 is formed to define the terminal edge 371. The end fold 384 corresponds to the distal end 375a of the heating element panel 375.

The end fold 384 forms the flap arrangement 385 of the resistive heating layer 340. First and second flaps 385a, 385b define the flap arrangement 385 and are defined by the end fold 340.

The first contact panel 376 comprises a first fold line portion 394a of the end fold 384. The first fold line portion 394a extends along the direction defined by the distal end 375a. As such, the end fold 384 defines the first flap 385a. The first flap 385a formed by the end fold will be sandwiched between the heating element panel layer and the contact panel layer when the aerosol generator 304 is formed. The first fold line portion 394a at least partially defines the terminal edge 371 of the aerosol generator 304.

The second contact panel 377 further comprises a second fold line portion 396a of the end fold 384. The second fold line portion 396a extends along the direction defined by the distal end 375a. The second flap 385b formed by the second fold line portion 396a will be sandwiched between the heating element panel layer and the contact panel layer when the aerosol generator 304 is formed. The second fold line portion 396a at least partially defines the terminal edge 371 of the aerosol generator. Moreover, the first and second fold line portion 394a, 396a combine to define the terminal edge 371 of the aerosol generator 382. In embodiments, the end fold comprises a single fold defining a single flap.

The blank 388 further comprises a support fold line 390. The support fold line 390 is arranged between the heating element panel 375 and the core panel 389. Folding the resistive heating layer 340 about the core fold line 390 forms a core that is positioned between the first and second sides of the aerosol generator 360. In such a way, the core underlays the heating element panel (and the resistive heating elements thereon) and the electrical contact panels (and the electrical contacts thereon). Advantageously, such a core would ensure consistent thickness of the aerosol generator. Moreover, such a core would also provide additional support to the heating elements and/or electrical contacts. Similar to the flaps discussed above in relation to FIG. 27, the core provides an extra layer of insulation between the resistive heating elements and an outer surface. In embodiments, the core fold line 390 may be omitted.

In some methods of manufacturing the aerosol generator, the blank 388 may be folded about the core fold line 390 such that the support panel 389 underlays the heating panel 375. In other methods, this step may be entirely omitted.

Referring now to FIG. 29, subsequent to folding of the support panel, the blank 388 is folded about the contact panel fold lines 394a, 396a to form the end fold 384 respectively. In other words, folding about the fold lines 394a, 396a results in the formation of the end fold 384. The fold line portions 394, 396 defines the electrical contact regions of both the first and second type of electrical contacts 360, 365. Again, the third and/or fourth fold 394, 396 has the advantages described above in relation to the end fold 384. In embodiments, this step can be performed before/without the folding of the support panel.

Referring now to FIG. 30, subsequent to folding about the third and fourth contact panel fold lines 370a, 378a, the blank 388 is further folded about the first and second contact panel fold lines 370a, 378a to form the first and second folds 370, 378 respectively. This results in the first and second contact panels 376, 377 at least partially defining the second surface and/or the second panel layer. This also results in the first and second type of electrical tracks 361, 366 extending from the first surface to the second surface and the positioning of the first and second type of electrical contacts 360, 365 on the second surface. This provides the advantages discussed above. In embodiments, this step can be performed before/without any of the above described steps.

Referring now to FIG. 31, subsequent to the folding about the first and second contact panel fold lines 370a, 378a, a base structure 396 of the aerosol generator 304 provided. An aerosol generating layer 330 can be deposited onto the resistive heating elements 342 of the base structure 388. Once the aerosol generating layer 330 is deposited on the resistive heating elements 342 an aerosol generator 304 would be provided.

In embodiments, different arrangements are possible. For example, in embodiments, the flap arrangement 385 extends from the longitudinal end of the heating element panel 375, similar to the arrangement shown in FIG. 2. The flap of the flap arrangement is folded to lie parallel to the heating element panel 375. In such an arrangement the electrical tracks are arranged to pass directly from the heating element panel 375 to the flap. The first and second panels 376, 377, described above as contact panels, or a single panel with a single longitudinal fold line in the aerosol generator 304, are free from electrical tracks, and act as cover panels. The flap of the flap arrangement is sandwiched between the first and second panels 376, 377 and the heating element panel 375. Accordingly, the path of the electrical tracks may be minimised. In a modification of such an embodiment, a first type of electrical contacts may be formed on the flap arrangement 385 extending directly from the heating element panel 375 defined by a fold line perpendicular to the longitudinal direction, and a second type of electrical contact may be formed on a contact panel defined by a fold line parallel to the longitudinal direction. In such an arrangement the first and second types of contact are spaced from each other.

In embodiments, the fold line defining the contact panel may be an end fold line extending perpendicular to the longitudinal direction, and the fold line forming a terminal edge may extend parallel to the longitudinal direction. Such an arrangement provides a terminal edge along the longitudinal extent of the aerosol generator 304.

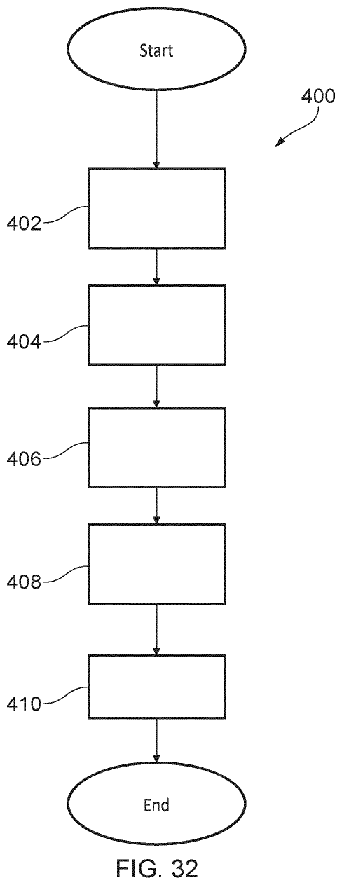

FIG. 32 shows a flowchart of a method 400 of manufacturing an aerosol generator. At step 402, a first type of electrical contact 360 of the aerosol generator is formed. For example, this may involve etching, either chemically or by a laser, a layer of conductive material. The layer of conductive material may be deposited on a support layer. The support layer may be board material such as paper or card. Additionally or alternatively, step 402 may comprise printing conductive material on to the layer of support material or on to the aerosol generating layer. The forming step 402 may also involve any of the techniques discussed above, e.g. such as the techniques discussed in relation to FIGS. 12, 13, and 16. In embodiments, the forming step 402 involves forming a plurality of the first type of electrical contact 360. The conductive material may be aluminium or any other conductive metal or metal alloy.

At step 404, a second type of electrical contact 365 of the aerosol generator is formed. The second type of electrical may be formed using any of techniques discussed in relation to the forming the first type of electrical contact. In other words, the description of step 402 applies analogously to the forming of the second type of electrical contact 365. In embodiments, the forming step 365 involves forming a plurality of the second type of electrical contact 365.

At step 406, a resistive heating element 342 is formed on the resistive heating layer 340. The resistive heating element 342 is formed to be at least a portion of an electrically conductive path between the first type of electrical contact 360 and the second type of electrical contact 365. The resistive heating element 342 may be formed using any of techniques discussed in relation to the forming the first type of electrical contact. The forming step 406 may involve forming a plurality of the resistive heating elements 342. Each of which may form a respective electrically conductive path between a respective first type of electrical contact 360 and a respective second type of electrical contact 365 or a common second type of electrical contact 365.

At step 408, an aerosol generating layer 330 comprising aerosol generating material 302 may be deposited on the resistive heating layer 340 such that the resistive heating element 342 can heat at least a portion of the aerosol generating material 302 to generate an aerosol.

At step 410, one of the first and second type of electrical contacts 360, 365 is folded such that the fold defines an electrical contact region of at least one of the first type of electrical contact 360 and the second type of electrical contact 365. One or more of the steps discussed above in relation to any of FIGS. 28 to 31 may be part of the folding step 410. The ordering of the step shown in FIGS. 28 and 32 are merely illustrative. In embodiments, the various steps may be performed in any order or any of the steps may be performed simultaneously as one or more of any of the other steps. The number of the step shown in FIGS. 28 and 32 are also merely illustrative. In embodiments, the any of the steps can be omitted.

In embodiments, the support layer on which the first and/or second type of electrical contacts is defined is also folded. In embodiments, the support layer on which the first and/or second type of electrical contacts is defined is free from a fold, for example the heating element layer extends beyond the support layer and folded around the support layer.

In the above embodiments, each of the fold lines are not pre-formed in a blank. In other embodiments, one or more the fold lines are pre-formed in the blank, for example a crease, or indent, or score, or any other weakening of the electrical contact and/or the support layer thereon.

In some embodiments of the different arrangements of aerosol generators and articles described above the aerosol generating material is formed in a configuration other than as an aerosol generating layer. The aerosol generating material in embodiments is in the form of an aerosol generating segment. The aerosol generating segment generally comprises a solid material. Such a solid material may be shredded tobacco. The aerosol generating material, arranged as an aerosol generating segment for example, may comprise a plurality of individual pieces of aerosol generating material. The aerosol generating material may be individual pieces of tobacco material. In embodiments, the aerosol generating material comprises a plurality of strips, beads or pellets. In embodiments the aerosol generating segment is a plug of material.

The aerosol generating segment in embodiments comprises a body of material. The aerosol generating material is a non-liquid. In such an embodiment, the body of material comprises a rod of aerosol generating material, for example a tobacco rod. For example, the body of material may comprise shredded tobacco material. The body of material may be formed into a rod. In some embodiments, the body of material comprises cut rag tobacco that is formed into a rod. The aerosol generating material may comprise tobacco material. The aerosol generating material may comprise extruded tobacco. The aerosol generating material may comprise reconstituted tobacco.

The aerosol generating material, formed as a solid material, may comprise nicotine. The aerosol generating material may comprises, consist of, or essentially consist of, tobacco. In embodiments, the aerosol generating material is free from tobacco.

In embodiments of any of the above, the heating of the article provides a relatively constant release of volatile compounds into an inhalable medium. In an embodiment of the above, the aerosol generating segment is a plug of material. The article may comprise a mouth end section. A tubular element may be located between the aerosol generating material and the mouth end section. The article may comprise a ventilation area in the mouth end section. The mouth end section may define a mouthpiece configured to be placed between a user's lips.

In embodiments of any of the above described articles, the or each resistive heating element is configured to heat substantially the entire aerosol generating material. The aerosol generating segment in embodiments is at least substantially cylindrical. In embodiments, the aerosol generating segment is at least partially wrapped by the resistive heating layer. In embodiments, the resistive heating element extends in the aerosol generating segment. The resistive heating element may extend around the aerosol generating segment. In embodiments, the resistive heating element encircles the aerosol generating segment. In some arrangements at least a portion of the flow path through the article is through the aerosol generating segment. The aerosol generating segment may define part of the air path. In embodiments, the first type of electrical contact and the second type of electrical contact are exposed from the aerosol generating segment.

The aerosol generating material may comprise tobacco material as described herein, which includes a tobacco component. In the tobacco material described herein, the tobacco component may contain paper reconstituted tobacco. The tobacco component may also contain leaf tobacco, extruded tobacco, and/or bandcast tobacco. The tobacco material may be provided in the form of cut rag tobacco. The cut rag tobacco can be formed from a mixture of forms of tobacco material, for instance a mixture of one or more of paper reconstituted tobacco, leaf tobacco, extruded tobacco and bandcast tobacco. In embodiments, the tobacco material comprises paper reconstituted tobacco or a mixture of paper reconstituted tobacco and leaf tobacco. In the tobacco material described herein, the tobacco material may contain a filler component. The filler component is generally a non-tobacco component, that is, a component that does not include ingredients originating from tobacco. The filler component may be a non-tobacco fibre such as wood fibre or pulp or wheat fibre. The filler component may also be an inorganic material such as chalk, perlite, vermiculite, diatomaceous earth, colloidal silica, magnesium oxide, magnesium sulphate, magnesium carbonate. The filler component may also be a non-tobacco cast material or a non-tobacco extruded material. The filler component may be present in an amount of 0 to 20% by weight of the tobacco material, or in an amount of from 1 to 10% by weight of the composition. In some embodiments, the filler component is absent. In the tobacco material described herein, the tobacco material contains an aerosol-former material. In this context, an “aerosol-former material” is an agent that promotes the generation of an aerosol. An aerosol-former material may promote the generation of an aerosol by promoting an initial vaporisation and/or the condensation of a gas to an inhalable solid and/or liquid aerosol. In some embodiments, an aerosol-former material may improve the delivery of flavour from the aerosol generating material. In general, any suitable aerosol-former material or agents may be included in the aerosol generating material of the invention, including those described herein.

Paper reconstituted tobacco refers to tobacco material formed by a process in which tobacco feedstock is extracted with a solvent to afford an extract of solubles and a residue comprising fibrous material, and then the extract (usually after concentration, and optionally after further processing) is recombined with fibrous material from the residue (usually after refining of the fibrous material, and optionally with the addition of a portion of non-tobacco fibres) by deposition of the extract onto the fibrous material. The process of recombination resembles the process for making paper.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. An aerosol generator of an article for an aerosol provision device comprising:
aerosol generating material;
a resistive heating layer comprising a resistive heating element configured to heat at least a portion of the aerosol generating material to generate an aerosol;
the aerosol generating material being on the resistive heating layer;
a first type of electrical contact;
a second type of electrical contact; and
a fold in the resistive heating layer to define an electrical contact region of at least one of the first type of electrical contact and the second type of electrical contact;
wherein the resistive heating element is at least a portion of an electrically conductive path between the first type of electrical contact and the second type of electrical contact.

2. The aerosol generator of claim 1, wherein at least one of the first type of electrical contact and the second type of electrical contact extends from the fold.

3. The aerosol generator of claim 1, wherein the first type of electrical contact and the second type of electrical contact extends from the fold.

4. The aerosol generator of claim 1 wherein the fold defines the electrical contact region of the at least one of the first type of electrical contact and the second type of electrical contact extending from the fold.

5. The aerosol generator of claim 1, wherein the aerosol generator is elongate and defines a longitudinal axis, the fold extending along an axis perpendicular to the longitudinal axis.

6. The aerosol generator of claim 5, wherein the fold defines a longitudinal end of the aerosol generator.

7. The aerosol generator of claim 1, wherein the aerosol generator is elongate and defines a longitudinal axis, the fold extending along an axis parallel to the longitudinal axis.

8. The aerosol generator of claim 1, wherein the fold is a first fold defining the first type of electrical contact; and comprising a second fold, the second fold defining the second type of electric contact.

9. The aerosol generator of claim 1, wherein the fold defines a terminal edge of the aerosol generator.

10. The aerosol generator of claim 1, wherein the resistive heating layer comprises a heating element panel comprising the resistive heating element and a contact panel comprising the at least one of the first type of electrical contact and the second type of electrical contact, wherein the fold is between the heating element panel and the contact panel.

11. The aerosol generator of claim 10, wherein the fold is a first fold, and comprising a second fold, wherein the first fold extends perpendicular to the second fold to define an end fold.

12. The aerosol generator of claim 11, wherein the first fold defines a flap.

13. The aerosol generator of claim 12, wherein the flap is sandwiched between the heating element panel and the contact panel.

14. The aerosol generator of claim 1, comprising an aerosol generating layer incorporating the aerosol generating material, and wherein the aerosol generating layer is on the resistive heating layer.

15. The aerosol generator of claim 1, comprising a support layer, wherein the resistive heating layer is on the support layer, and wherein each of the resistive heating layer and the support layer are folded at the fold.

16. (canceled)

17. (canceled)

18. An aerosol generating system comprising:
an article comprising the aerosol generator of claim 1; and an aerosol provision device configured to receive the article.

19. (canceled)

20. A method of manufacturing an aerosol generator, the method comprising:
providing a resistive heating layer;
forming a first type of electrical contact of the aerosol generator;
forming a second type of electrical contact of the aerosol generator;
forming a resistive heating element on the resistive heating layer, wherein the resistive heating element is at least a portion of an electrically conductive path between the first type of electrical contact and the second type of electrical contact; and
folding the resistive heating layer about a fold line to form a fold that defines an electrical contact region of at least one of the first type of electrical contact and the second type of electrical contact.
